(19) United States
(12) Patent Application Publication
(10) Pub. No.: US 2026/0124710 A1
(43) Pub. Date: May 7, 2026

(54) AUTOMATIC GRINDING LINE FOR GRINDING MPO OPTICAL FIBER JUMPER

(71) Applicant: Phoenix GT Technology (Shenzhen) Co., Ltd, Shenzhen (CN)

(72) Inventors: Gaosheng Li, Shenzhen (CN); Jiangang Zhang, Shenzhen (CN)

(21) Appl. No.: 19/307,431

(22) Filed: Aug. 22, 2025

(30) Foreign Application Priority Data
Nov. 7, 2024 (CN) 202411583469.2

(51) Int. Cl. B24B 19/22; B24B 41/02; G02B 6/38

(52) U.S. Cl. CPC B24B 19/22; B24B 41/02; G02B 6/3863

(57) ABSTRACT

Provided is an automatic grinding line for grinding MPO optical fiber jumper. The automatic grinding line include a plurality of grinding units arranged side by side. The table of each grinding unit is provided with a grinding machine for placing a grinding fixture and a cleaning machine for cleaning the grinding fixture. The table of each grinding unit is further provided with a grinding support frame, and the grinding support frame is provided with a linear sliding assembly located above the grinding machine and the cleaning machine. A pair of fixture clamping assemblies for clamping the grinding fixture are connected to the linear sliding assembly in a sliding manner, and the linear sliding assembly is used for driving the pair of fixture clamping assemblies to perform synchronous linear reciprocating motion and clamp the optical fiber grinding fixture to move synchronously, the grinding efficiency is effectively improved.

### CROSS-REFERENCE TO RELATED APPLICATIONS

This application claims to the benefit of priority from Chinese Application No. 202411583469.2 with a filing date of Nov. 7, 2024. The content of the aforementioned applications, including any intervening amendments thereto, are incorporated herein by reference.

### TECHNICAL FIELD

The present disclosure relates to the technical field of optical fiber jumper grinding, in particular to an automatic grinding line for grinding MPO (multi-fiber push on) optical fiber jumper.

### BACKGROUND

The polishing of MPO (multi-fiber push on) optical fiber jumper is generally divided into five processes namely degumming, coarse grinding, fine grinding, fiber drawing, and polishing. In each process, separate grinding fixtures need to be assembled and grounding or polishing performs on a separate optical fiber grinding machine. However, due to the pigtail of the MPO optical fiber jumper is long, the weight of a reel of MPO optical fiber jumper can generally reach 50-100KG, thus, when using separate optical fiber grinding machine for grinding or polishing, it is necessary to disassemble the grinding fixture to clean the end face of the MPO optical fiber jumper after the grinding or polishing is completed, then the grinding fixture is assembled on optical fiber grinding machine of the next process to continue grinding. As the pigtail of the MPO optical fiber jumper is heavy, the turnover of the MPO optical fiber jumper during grinding is inconvenient, thereby lowing the grinding efficiency.

### SUMMARY

In order to solve the above technical problems, the purpose of the present disclosure is to provide an automatic grinding line for grinding MPO optical fiber jumper. The grinding line consists of a grinding machine and a cleaning machine arranged side by side, and the grinding and cleaning processes are carried out in sequence without the need for manual replacement of grinding fixtures, effectively improving grinding efficiency.

In order to achieve the above objectives, the technical solution adopted by the present disclosure is:
An automatic grinding line for grinding MPO (multi-fiber push on) optical fiber jumper, including a plurality of grinding units arranged side by side, each grinding unit is provided with a grinding machine for placing a grinding fixture and a cleaning machine for cleaning a grinding fixture, each grinding unit is further provided with a grinding support frame, the grinding support frame is provided with a linear sliding assembly located above the grinding machine and the cleaning machine, a pair of fixture clamping assemblies for clamping the grinding fixture are connected to the linear sliding assembly in a sliding manner, and the linear sliding assembly is used for driving the pair of fixture clamping assemblies to perform synchronous linear reciprocating motion and clamp the grinding clamp to move synchronously. A conveyor belt is further arranged on the grinding unit, and both ends of the conveyor belt extend to both ends of the grinding unit.

Further, a cable box is placed on the conveyor belt.

Further, at least a vertical pressurizing assembly is arranged on the fixture clamping assembly located on one side the grinding machine, the vertical pressurizing assembly is used to apply pressure to the grinding fixture located on the grinding machine.

Further, fixture placement plates extending outward from the grinding unit are respectively arranged on both ends of the grinding unit.

Further, a support frame assembly is further arranged on the grinding unit, and one end of the vertical pressurizing assembly is connected to the support frame assembly in a sliding manner.

Further, the support frame assembly includes a pair of support columns arranged at intervals, a linear guide plate, and a sliding plate, the linear guide plate is arranged at upper ends of the support columns, the sliding plate is arranged on one side of the vertical pressurizing assembly, the other side of the sliding plate is connected to the linear guide plate in a sliding manner.

Further, the linear sliding assembly includes a linear displacement sliding table, a linear sliding plate, and a connecting plate, the linear displacement sliding table is connected to the linear sliding plate in a sliding manner, the connecting plate is arranged on the linear sliding plate, the connecting plate is parallel to and spaced apart from the linear displacement sliding table, and a pair of fixture clamping assemblies are spaced apart on the connecting plate.

Further, each fixture clamping assembly includes a vertical lifting slide table, a lifting slide plate, a fixture cylinder, and a clamping plate, a bottom of the vertical lifting slide table is connected to the connecting plate, the vertical lifting slide table is connected to the lifting slide plate in a sliding manner, a lower end of the lifting slide plate is provided with a fixture cylinder, and clamping plates for clamping the grinding fixture are connected to both clamping ends of the fixture cylinder.

Further, the vertical pressurizing assembly includes a pressurizing cylinder, a proportional valve, and a pressurizing top rod, the pressurizing cylinder is arranged at an end of the fixture cylinder and located between a pair of clamping plates, the pressurizing top rod is arranged at a telescopic end of the pressurizing cylinder, the proportional valve is arranged on the pressurizing cylinder, and the pressurizing cylinder is controlled by the proportional valve to drive the pressurizing top rod downward to pressurize the grinding fixture located on the grinding machine.

Further, the lower end of the lifting sliding plate is further provided with a longitudinal telescopic assembly, the fixture cylinder is arranged on the longitudinal telescopic assembly, the sliding plate is arranged on one side of the pressurizing cylinder, and opposite to the fixture cylinder.

The present disclosure has the following advantages and effects due to the adoption of the above technical solutions:
The an automatic grinding line for grinding MPO optical fiber jumper provided by the disclosure is an array configuration, and consists of a plurality of grinding machines and cleaning machines. Each grinder and cleaning machine forms a workstation. The PLC controller can used to uniformly control a plurality of workstations for synchronous assembly line operations, without the need for manual replacement of grinding fixtures. In addition, the pigtail cable of the MPO optical fiber jumper is placed on the conveyor belt for synchronous transmission, without the need for manual handling and turnover, effectively improving the grinding efficiency of such products.

### BRIEF DESCRIPTION OF THE DRAWINGS

FIG. 1 is a structural schematic diagram of the automatic grinding line of the present disclosure.

FIG. 2 is an exploded view of the automatic grinding line of the present disclosure.

FIG. 3 is an isometric structural schematic diagram of the grinding unit of the present disclosure.

FIG. 4 is the front view of FIG. 3.

FIG. 5 is the rear view of FIG. 3.

FIG. 6 is a side view of FIG. 3.

FIG. 7 is a first structural schematic diagram of the assembly of a cleaning machine, a grinding machine, a grinding fixture, a linear sliding assembly, and a fixture clamping assembly of the grinding unit of the present disclosure.

FIG. 8 is a second structural schematic diagram of the assembly of the cleaning machine, the grinding machine, the grinding fixture, the linear sliding assembly, and the fixture clamping assembly of the grinding unit of the present disclosure.

FIG. 9 is a first isometric structural schematic diagram of the linear sliding assembly of the present disclosure.

FIG. 10 is a second isometric structural schematic diagram of the linear sliding assembly of the present disclosure.

FIG. 11 is a first structural schematic diagram of the assembly of the fixture clamping assembly and a vertical pressurizing assembly of the present disclosure.

FIG. 12 is a second structural schematic diagram of the assembly of the fixture clamping assembly and the vertical pressurizing assembly of the present disclosure.

FIG. 13 is an isometric structural schematic diagram of the pressurizing cylinder of the present disclosure.

Reference numbers in the drawings: 1-grinding unit, 101-cleaning machine, 102-grinding machine, 103-grinding fixture, 104-grinding machine cabinet, 1041-universal wheel, 1042-support base, 105-linear sliding assembly, 1051-linear displacement sliding table, 1052-linear sliding plate, 1053-connecting plate, 106-fixture clamping assembly, 1061-vertical lifting sliding table, 1062-lifting sliding plate, 1063-fixture cylinder, 1064-clamping plate, 1065-L-shaped sliding plate, 107-grinding support frame, 108-support frame assembly, 1081-linear guide plate, 1082-support column, 1083-sliding plate, 109-vertical pressurizing assembly, 1091-pressurizing cylinder, 1092-pressurizing top rod, 110-longitudinal telescopic assembly, 2-fixture placement plate, 3-conveyor belt, 4-protective cover, 401-cable box.

### DESCRIPTION OF EMBODIMENTS

The following will provide a detailed illustration of the embodiments of the present disclosure in conjunction with the accompanying drawings, in order to better understand the purpose, features, and advantages of the present disclosure. It should be understood that the embodiments shown in the accompanying drawings are not intended to limit the scope of the present disclosure, but only to illustrate the essential spirit of the technical solution of the present disclosure.

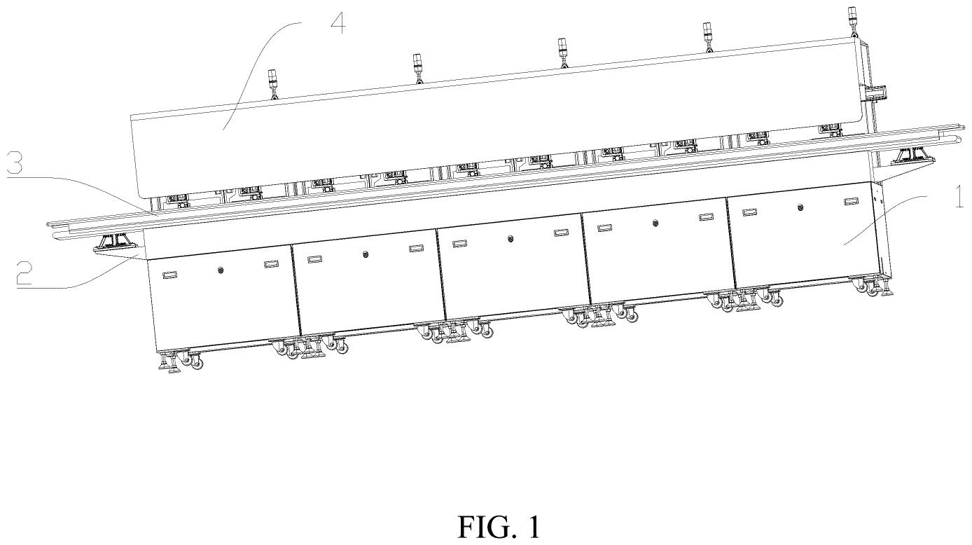

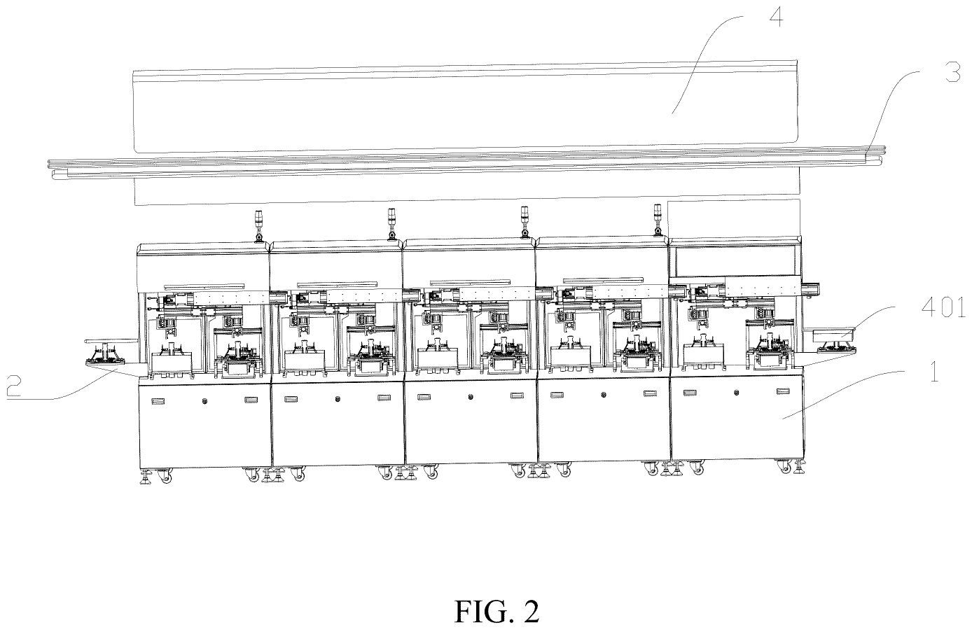

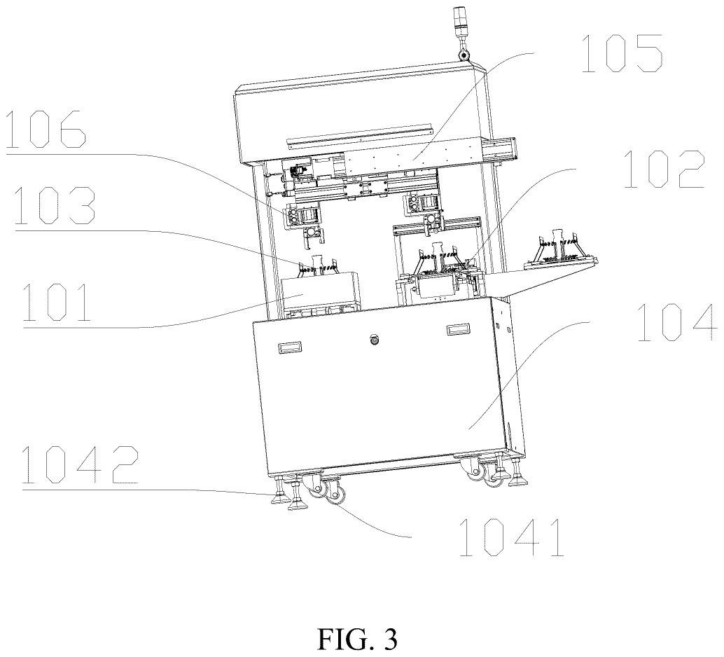

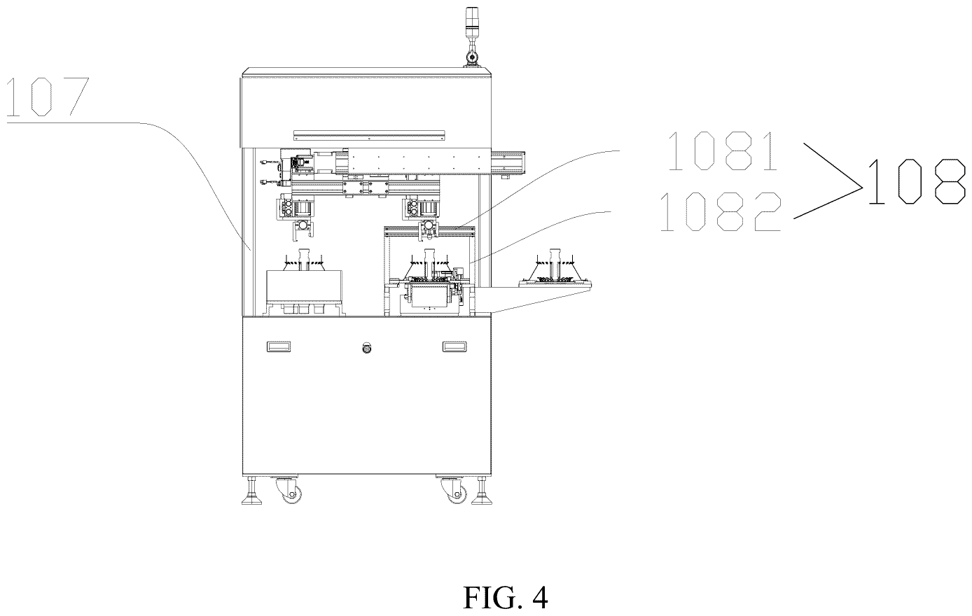

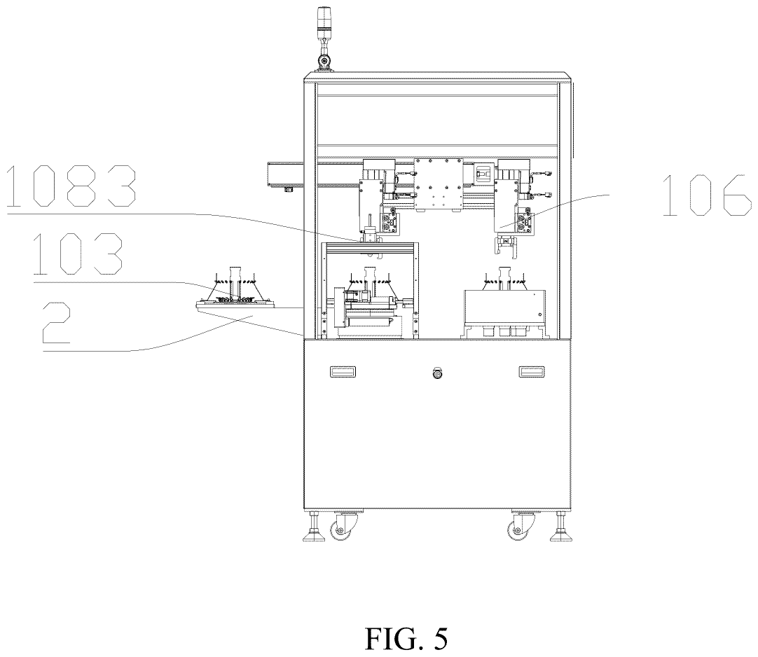

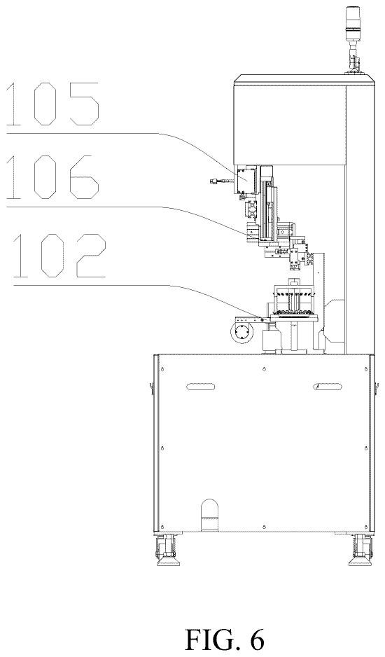

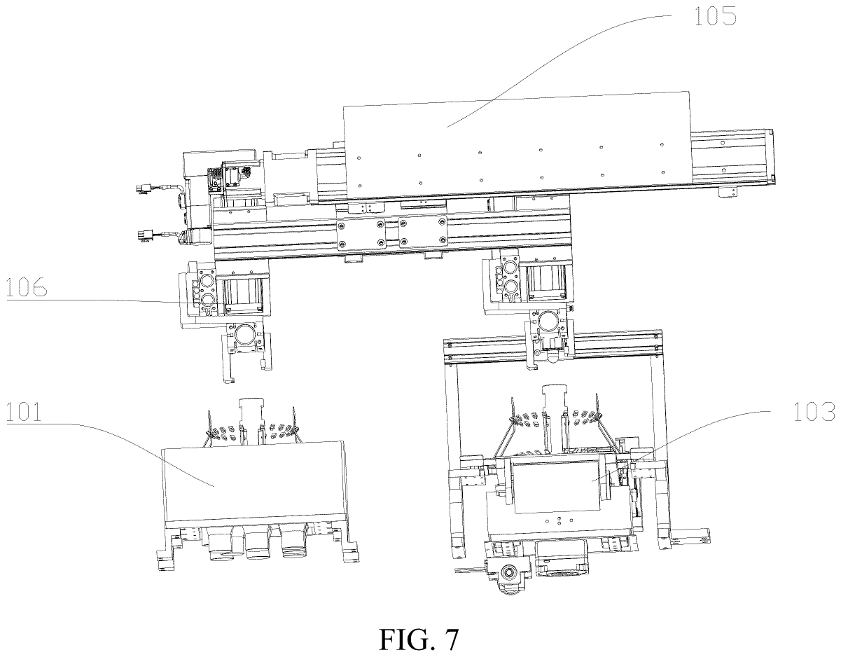

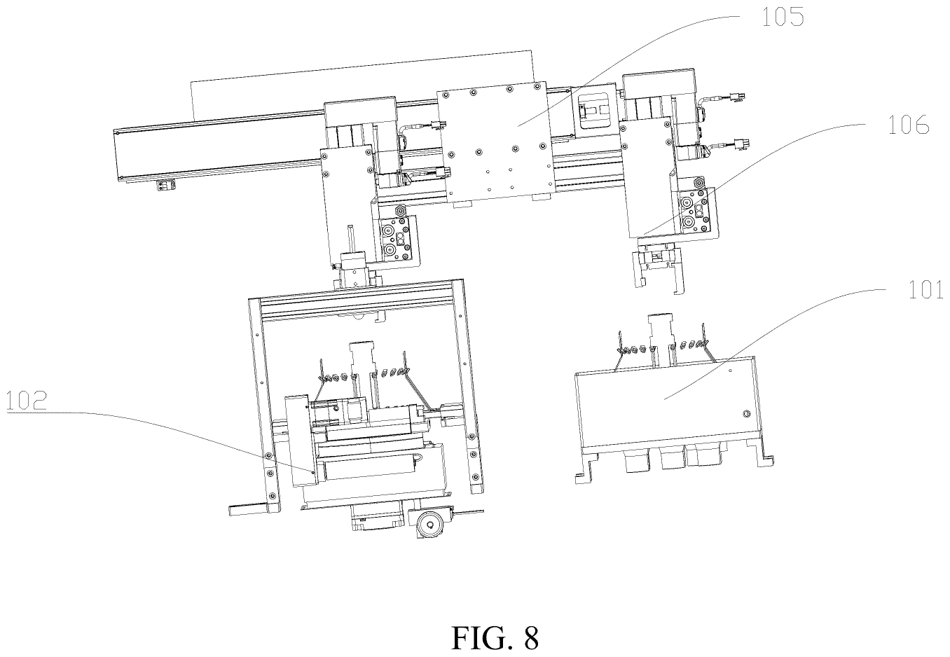

As shown in FIG. 1 to FIG. 8 and FIG. 11 to FIG. 12, the present disclosure provides an automatic grinding line for grinding MPO (multi-fiber push on) optical fiber jumper, which includes a plurality of grinding units 1 arranged side by side. The table of each grinding unit 1 is provided with a grinding machine 102 for placing a grinding fixture 103 and a cleaning machine 101 for cleaning the grinding fixture 103. The table of each grinding unit 1 is further provided with a grinding support frame 107, and the grinding support frame 107 is provided with a linear sliding assembly 105 located above the grinding machine 102 and the cleaning machine 101. A pair of fixture clamping assemblies 106 for clamping the grinding fixture 103 are connected to the linear sliding assembly 105 in a sliding manner, the linear sliding assembly 105 drives the pair of fixture clamping assemblies 106 into straight reciprocating motion synchronously to clamp the grinding clamp 103 to move synchronously.

Specifically, according to the present disclosure, five sets of the grinding units 1 are arranged side by side to compose an automatic grinding line, which includes degumming grinding, coarse grinding, fine grinding, fiber drawing grinding, and polishing grinding in sequence. Of course, different numbers of grinding units 1 can be set up according to different grinding processes to compose an automatic grinding line.

The grinding unit 1 includes a grinding machine cabinet 104. Universal wheels 1041 and support bases 1042 are arranged around the bottom of the grinding machine cabinet 104 to facilitate movement and support. The grinding machines 102 and the cleaning machines 101 are horizontally arranged in alternate. On the middle of the table of the grinding machine cabinet 104, one grinding machine 102 and one cleaning machine 101 are arranged side by side to form one set of the grinding unit 1. A grinding support frame 107 is arranged at the rear end of the table of the grinding machine cabinet 104. The grinding support frame 107 is a portal frame, and the columns on both sides of the portal frame are fixed on the table. The upper end of the grinding support frame 107 extends towards the front side of the grinding machine cabinet 104, and a linear sliding assembly 105 is arranged at the extended end of the the grinding support frame 107. The linear sliding assembly 105 is located at the upper end of the grinding machine 102 and the cleaning machine 101.

The grinding machine 102 of each grinding unit 1 is used to grind a MPO optical fiber jumper connector clamped on the grinding fixture 103, and the cleaning machine 101 is used to clean a MPO optical fiber jumper connector on the corresponding grinding fixture 103 after grinding.

The grinding machine 102 is preferably an automatic grinding machine for an optical fiber connector disclosed by the application with publication number CN221583210U, and the cleaning machine 101 is preferably an ultrasonic cleaner.

When the grinding unit 1 is working, the linear sliding assembly 105 on each grinding unit 1 drives synchronously a pair of grinding fixtures 103 connected to the linear sliding assembly 105 to move towards one side of the outer end of the grinding machine 102 of the grinding unit 1 to grab the unground fixture 103 or the ground grinding fixture 103 on adjacent sides, and then move towards the other side to place the grabbed grinding fixture 103 on the corresponding workstation of the cleaning machine 101 or the grinding machine 102 for synchronous cleaning or grinding, reciprocating in sequence to achieve the parallel transmission of the grinding fixture 103 on the adjacent grinding unit 1, until the cleaning is completed from the last grinding unit 1, so that the entire grinding process is completed.

A protective cover 4 is arranged on the front side of the extended end of the grinding support frame 107 of the grinding unit 1. The protective cover 4 protects the cleaning machine 101 and the grinding machine 102 on the grinding unit 1, avoiding splashing of grinding liquid or cleaning liquid when grinding or cleaning the grinding fixture 103.

Meanwhile, a protective door is arranged behind the grinding support frame 107 of each grinding unit 1, which facilitates the installation and debugging of grinding machine 102 or cleaning machine 101 through the protective door.

Further, a conveyor belt 3 is further arranged on the table of the grinding unit 1, and the conveyor belt 3 extends from both ends of the grinding unit 1.

Specifically, a conveyor belt 3 is arranged on the front side of the upper end of the table of the grinding machine cabinet 104. The conveyor belt 3 is used to transmit the pigtailr cable of the MPO optical fiber jumper. When the optical fiber connector on the MPO optical fiber jumper is fixed on the grinding fixture 103 and transported sequentially through the linear sliding assembly 105, the pigtailr cable of the MPO optical fiber jumper is placed on the conveyor belt 3 for synchronous transmission.

Of course, to facilitate the transmission of pigtailr cables, a cable box 401 is arranged on the conveyor belt 3, and the corresponding pigtailr cables on each grinding fixture 103 can be placed in the corresponding cable box 401 for synchronous transmission.

Further, a vertical pressurizing component 109 is at least arranged on the fixture clamping assembly 106 located on one side above the grinding machine 102.

Specifically, in the present disclosure, a vertical pressurizing component 109 is arranged on the corresponding fixture clamping assembly 106 on one side of the grinding machine 102 where needs to be pressurized. When the grinding fixture 103 is transferred to the corresponding grinding machine, a pressure is applied to the grinding fixture 103 through the vertical pressurizing component 109.

Further, to facilitate the pressurization of the vertical pressurizing component 109, a support frame component 108 is further arranged on the table of the grinding unit 1, and one end of the vertical pressurizing component 109 is connected to the support frame component 108 in a sliding manner. The support frame component 108 is fixed on both sides of the corresponding grinding machine 101, and when the vertical pressurizing component 109 presses downwards, some support is provided on the grinding machine 101 by the support frame component 108.

Further, as the grinding fixture 103 needs to enter and exit from both sides of the grinding unit 1, fixture placement plates 2 extending outward from the grinding unit 1 are respectively arranged on the grinding units 1 located at both ends.

Specifically, the grinding fixture 103 for the initial process before degumming and the grinding fixture 103 for the completed grinding can be placed on the fixture placement plate 2, so that the fixture clamping assembly 106 of the grinding unit 1 of the first process can clamp the grinding fixture 103 of the initial process from the outer side, while the fixture clamping assembly 106 of the grinding unit 1 of the last process can place the grinding fixture 103 that completed grinding on the fixture placement plate 2 for manual removal, meanwhile, make room for grinding fixture of the previous process.

Further, the support frame component 108 includes a pair of support columns 1082 arranged at intervals, a linear guide plate 1081, and a sliding plate 1083. A linear guide plate 1081 is arranged at upper end of the support columns 1082, the sliding plate 1083 is arranged on one side of the vertical pressurizing component 109, the other side of the sliding plate 1083 is connected to the linear guide plate 1081 in a sliding manner.

Specifically, the support columns 1082 are respectively arranged on both sides of the grinding machine 102 and integrated with the fixing frame of the grinding fixture. One side of the sliding plate 1083 is embedded in the linear guide plate 1081 and can slide away from the linear guide plate 1081. When the fixture clamping assembly 106 moves to the adjacent workstation to grasp the grinding fixture 103, the sliding plate 1083 separates from the linear guide plate 1081. When the fixture clamping assembly 106 is reset after clamping the grinding fixture 103, the fixture clamping assembly 106 can drive the sliding plate 1083 to be embedded in one side of the linear guide plate 1081. Therefore, when the grinding fixture 103 needs to be pressurized, the support frame component 108 can provide stable support force.

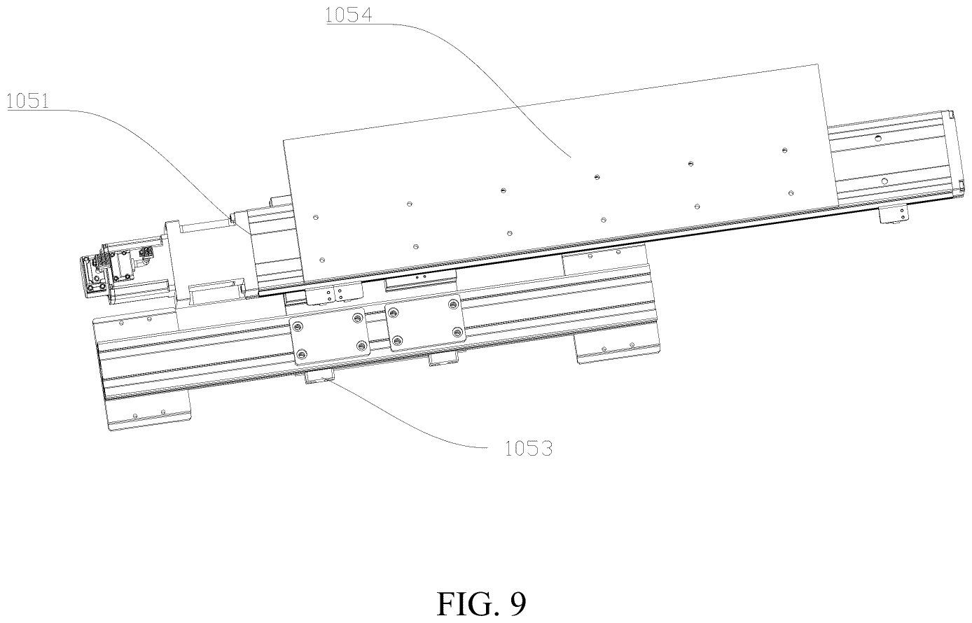

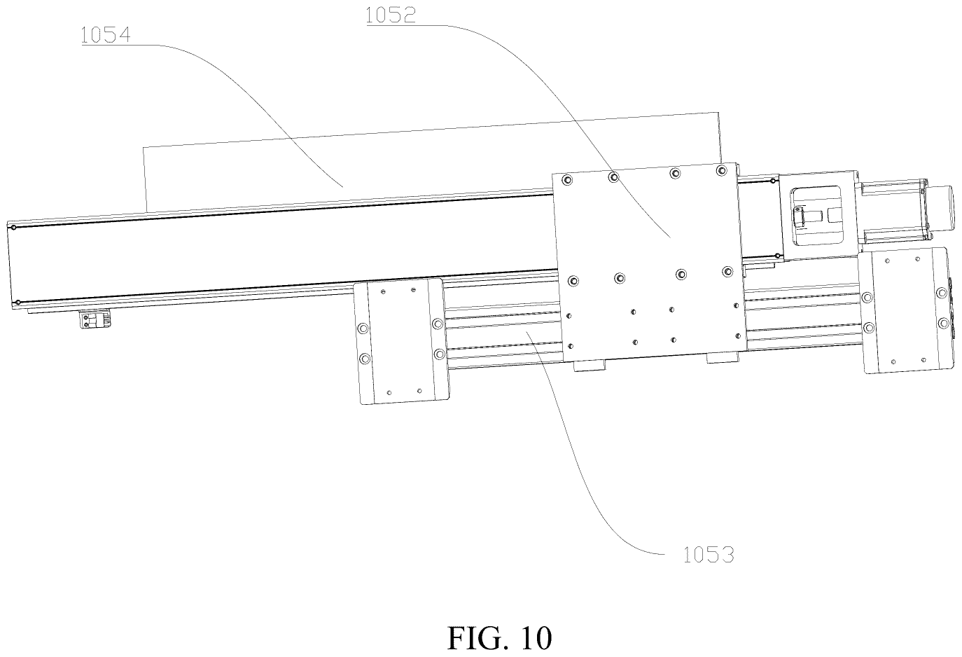

As shown in FIG. 9 and FIG. 10. Further, the linear sliding assembly 105 includes a linear displacement sliding table 1051, a linear sliding plate 1052, and a connecting plate 1053. The linear displacement sliding table 1051 is connected to the linear sliding plate 1052 in a sliding manner, and a connecting plate 1053 is arranged on the linear sliding plate 1052, the connecting plate 1053 is parallel to and spaced apart from the linear displacement sliding table 1051, and a pair of fixture clamping assemblies 106 are arranged at intervals on the connecting plate 1053.

Specifically, the bottom of the linear displacement sliding table 1051 is fixed to the extension end of the front side of upper end of the grinding support frame 107 through an extension plate 1054, and the linear sliding plate 1052 is embedded in the slider at the top of the linear displacement sliding table 1051. The middle of the connecting plate 1053 is fixed on the linear sliding plate 1052, and both ends of the connecting plate 1053 extending out of the linear sliding plate 1052 are provided with fixture clamping assemblies 106. The fixture clamping assemblies 106 are perpendicular to the connecting plate 1053, and the distance between a pair of fixture clamping assemblies 106 is the same as the distance between the grinding machine 102 and the cleaning machine 101, making it easy for adjacent fixture clamping assemblies 106 on the entire grinding unit 1 to move the same distance each time and be placed on the corresponding grinding machine 102 and cleaning machine 101. The linear displacement sliding table 1051 is preferably an electric sliding table, and electric sliding table is driven by a motor to rotate the screw and move the slider in a straight line.

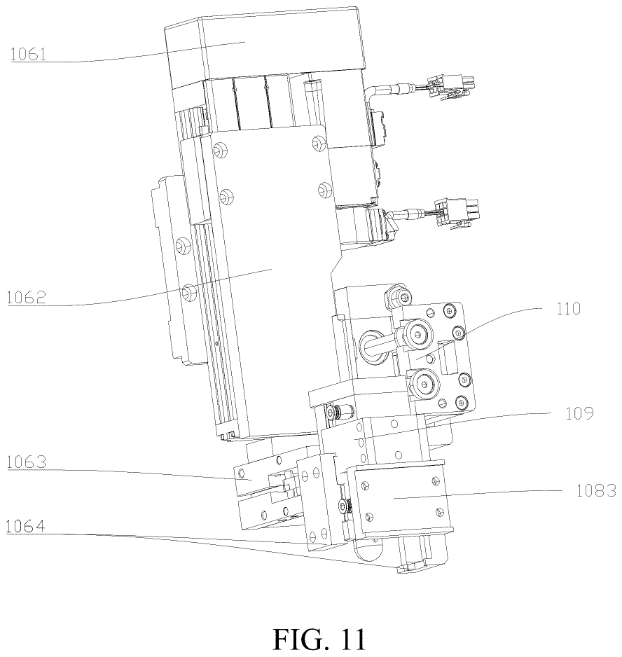

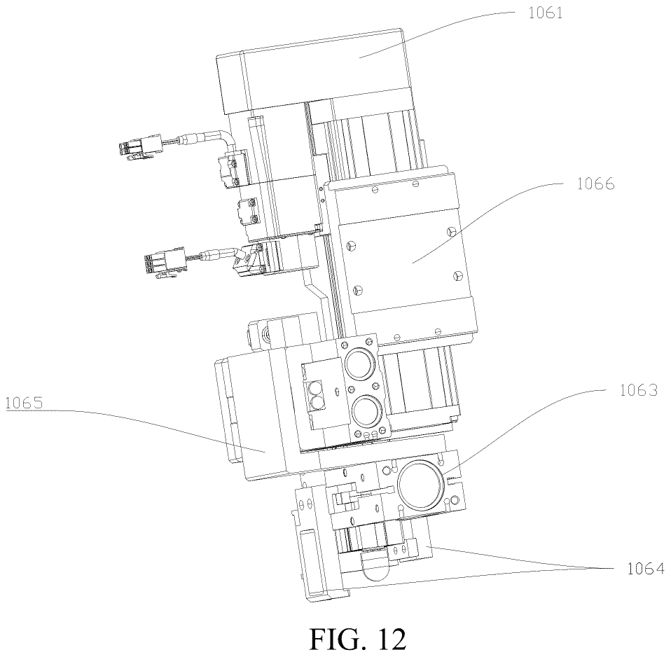

As shown again in FIG. 11 and FIG. 12. Further, the fixture clamping assembly 106 includes a vertical lifting slide table 1061, a lifting slide plate 1062, a fixture cylinder 1063, and a clamping plate 1064. The bottom of the vertical lifting slide table 1061 is connected to the connecting plate 1053, and the vertical lifting slide table 1061 is connected to the lifting slide plate 1062 in a sliding manner. The lower end of the lifting slide plate 1062 is provided with a fixture cylinder 1063, and both clamping ends of the fixture cylinder 1063 are connected to the clamping plate 1064 for clamping the grinding fixture 103.

Specifically, the bottom of the vertical lifting sliding table 1061 is connected to the connecting plate 1053 through a support plate. The vertical lifting sliding table 1061 is perpendicular to the connecting plate 1053, the lifting sliding plate 1062 is connected to the vertical lifting sliding table 1061, and when the slider of the vertical lifting sliding table 1061 moves to the upper end of the vertical lifting sliding table 1061, the lower end of the lifting sliding plate 1062 extends to the lower end of the vertical lifting sliding table 1061 for downward movement to clamp the grinding fixture 103.

The vertical lifting sliding table 1061 is preferably an electric sliding table. The fixture cylinder 1063 is a finger cylinder with two opposing clamping ends. The model of the fixture cylinder 1063 is preferably the Yadek AIRTAC finger cylinder HFP32. A pair of clamping plates 1064 are perpendicular and connected to the two clamping ends of the finger cylinder, and the pair of clamping plates 1064 are spaced apart to facilitate clamping the pressurizing column on the grinding fixture 103.

Further, to facilitate adjusting of the position of the fixture cylinder 1063 to correspond with the grinding fixture 103, the lower end of the lifting sliding plate 1062 is further provided with a longitudinal telescopic component 110, and the fixture cylinder 1063 is arranged on the longitudinal telescopic component 110. The longitudinal telescopic component 110 can adjust the longitudinal position of the fixture cylinder 1063 above the grinding machine.

A telescopic end of one side of the longitudinal telescopic component 110 is connected to the L-shaped sliding plate 1065, and A fixed end of one side of the longitudinal telescopic component 110 is connected to the lifting sliding plate 1062. The fixture cylinder 1063 is arranged at the lower end of the L-shaped sliding plate 1065. The longitudinal telescopic component 110 is a telescopic cylinder or an electric sliding table. The fixture cylinder 1063 is connected to the telescopic end of the telescopic cylinder or the slider of the electric sliding table. The model of telescopic cylinder is preferably HLS 20×50.

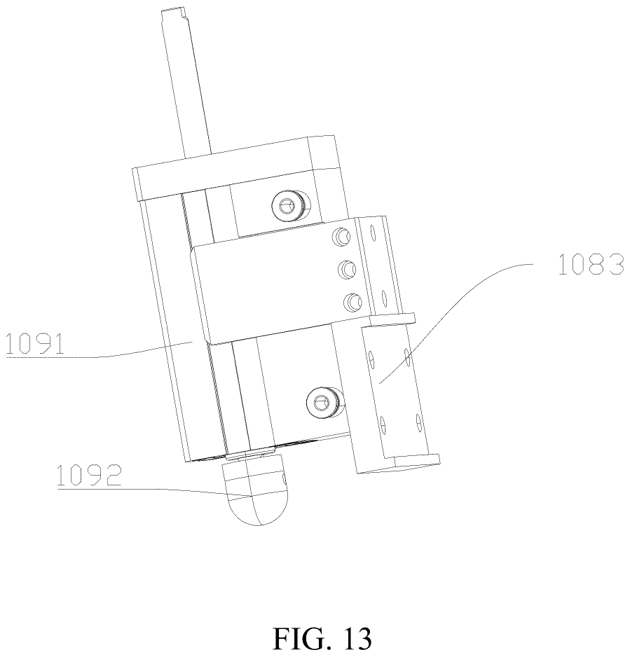

As shown in FIG. 13. Further, the vertical pressurizing component 109 includes a pressurizing cylinder 1091, a proportional valve, and a pressurizing top rod 1092. The pressurizing cylinder 1091 is arranged at the end of the fixture cylinder 1063 and located between a pair of clamping plates 1064. The pressurizing top rod 1092 is arranged at the telescopic end of the pressurizing cylinder 1091, and a proportional valve is arranged on the pressurizing cylinder 1091. The pressurizing cylinder 1091 is controlled by a proportional valve to drive the pressurizing top rod 1092 downward to pressurize the grinding fixture 103 located on the grinding machine 102.

Specifically, one side of the pressurizing cylinder 1091 is fixed at the end of the fixture cylinder 1063 between a pair of clamping plates 1064. When it is necessary to apply pressure to the grinding fixture 103, the grinding fixture 103 is moved to the grinding machine 102 by clamping the pressurizing column on the grinding fixture 103 with the pair of clamping plates 1064 on the fixture cylinder 1063. Then the pressurizing cylinder 1091 drives the pressurizing top rod 1092 downward to apply pressure to the pressurizing column. The upper end and lower end of the pressurizing cylinder 1091 are respectively provided with an air inlet and an air outlet. The proportional valve is arranged at the air source port of the pressurizing cylinder 1091 through the air inlet and the air outlet, ensuring the tight and reliable connection between the proportional valve and the air source and the pressurizing cylinder 1091. The control signal line of the proportional valve is connected to the controller, and the pressure regulation of the pressurizing cylinder 1091 is achieved by controlling the proportional valve through the controller. The model of the pressurizing cylinder 1091 is preferably SDADS 20×50.

Further, the sliding plate 1083 is arranged on one side of the pressurizing cylinder 1091, and opposite to the fixture cylinder 1063. One side of the sliding plate 1083 is fixed to the pressurizing cylinder 1091, and a U-shaped groove is formed on other side of the sliding plate 1083. The U-shaped groove is embedded into one side of the linear guide plate 1081 and slides along the linear guide plate 1081. When the pressurizing cylinder 1091 drives the pressurizing top rod 1092 to pressurize downwards, the sliding plate 1083 is supported by the linear guide plate 1081 to provide support force.

When using the automatic grinding line, the grinding unit 1 is assembled according to different grinding processes. The first grinding fixture 103 is placed on the fixture placement plate on the outer side of the grinding unit 1 in the first process, all grinding units are synchronously started, and the fixture clamping assemblies 106 on the grinding units 1 move synchronously. The fixture clamping assembly on the grinding unit in the first process moves the grinding fixture 103 to the optical fiber grinding machine of the grinding unit in the first process for grinding. Then the second grinding fixture is placed on the fixture placement plate. After the grinding fixture on the grinding unit 1 in the first process is completed, the fixture clamping assembly moves synchronously and clamps the second grinding fixture, and the first grinding fixture is clamped and moved to the cleaning machine of the grinding unit in the first process for cleaning; after the grinding unit in the first process completes grinding and cleaning, the third grinding fixture continues to be placed, the fixture clamping assembly of grinding unit 1 in the second process moves synchronously to continue clamping the third grinding fixture, and the fixture clamping assembly of the grinding unit 1 in the second process moves to clamp the grinding fixture cleaned in the first process. So the cycle continues, the grinding and cleaning of grinding fixtures on adjacent grinding units are sequentially ground and cleaned until the last process is cleaned, and the grinding fixture is moved to the fixture placement plate outer side the grinding unit in the last process after cleaning is completed. During the entire grinding and cleaning process, the pigtail cables on the grinding fixture are placed in the cable box on the conveyor belt for transportation.

According to the present disclosure, the corresponding action sequence is controlled by programming through PLC controller (Programmable Logic Controller). The PLC controller is an existing technology, which will not be described in detail for brevity.

Finally, it should be noted that the above embodiments are only used to illustrate the technical solution of the present disclosure, and not to limit it. Although the present disclosure has been described in detail with reference to the aforementioned embodiments, those skilled in the art should understand that they can still modify the technical solutions described in the aforementioned embodiments, or equivalently replace some of the technical features. And these modifications or substitutions do not depart from the essence and scope of the corresponding technical solutions of the embodiments of the present disclosure.

What is claimed is:

1. An automatic grinding line for grinding MPO (multi-fiber push on) optical fiber jumper, comprising a plurality of grinding units arranged side by side, each grinding unit is provided with a grinding machine for placing a grinding fixture and a cleaning machine for cleaning a grinding fixture, each grinding unit is further provided with a grinding support frame, the grinding support frame is provided with a linear sliding assembly located above the grinding machine and the cleaning machine, a pair of fixture clamping assemblies for clamping the grinding fixture are connected to the linear sliding assembly in a sliding manner, and the linear sliding assembly is used for driving the pair of fixture clamping assemblies to perform synchronous linear reciprocating motion and clamp the grinding clamp to move synchronously.

2. The automatic grinding line for grinding MPO optical fiber jumper according to claim 1, a conveyor belt is further arranged on the grinding unit, and both ends of the conveyor belt extend to both ends of the grinding unit.

3. The automatic grinding line for grinding MPO optical fiber jumper according to claim 1, at least a vertical pressurizing assembly is at least arranged on the fixture clamping assembly located on one side the grinding machine, the vertical pressurizing assembly is used to apply pressure to the grinding fixture located on the grinding machine.

4. The automatic grinding line for grinding MPO optical fiber jumper according to claim 3, fixture placement plates extending outward from the grinding unit are respectively arranged on both ends of the grinding unit.

5. The automatic grinding line for grinding MPO optical fiber jumper according to claim 3, a support frame assembly is further arranged on the grinding unit, and one end of the vertical pressurizing assembly is connected to the support frame assembly in a sliding manner.

6. The automatic grinding line for grinding MPO optical fiber jumper according to claim 5, the support frame assembly comprises a pair of support columns arranged at intervals, a linear guide plate, and a sliding plate, the linear guide plate is arranged at upper ends of the support columns, the sliding plate is arranged on one side of the vertical pressurizing assembly, the other side of the sliding plate is connected to the linear guide plate in a sliding manner.

7. The automatic grinding line for grinding MPO optical fiber jumper according to claim 6, the linear sliding assembly comprises a linear displacement sliding table, a linear sliding plate, and a connecting plate, the linear displacement sliding table is connected to the linear sliding plate in a sliding manner, the connecting plate is arranged on the linear sliding plate, the connecting plate is parallel to and spaced apart from the linear displacement sliding table, and a pair of fixture clamping assemblies are spaced apart on the connecting plate.

8. The automatic grinding line for grinding MPO optical fiber jumper according to claim 7, each fixture clamping assembly comprises a vertical lifting slide table, a lifting slide plate, a fixture cylinder, and a clamping plate, a bottom of the vertical lifting slide table is connected to the connecting plate, the vertical lifting slide table is connected to the lifting slide plate in a sliding manner, a lower end of the lifting slide plate is provided with a fixture cylinder, and clamping plates for clamping the grinding fixture are connected to both clamping ends of the fixture cylinder.

9. The automatic grinding line for grinding MPO optical fiber jumper according to claim 8, the vertical pressurizing assembly comprises a pressurizing cylinder, a proportional valve, and a pressurizing top rod, the pressurizing cylinder is arranged at an end of the fixture cylinder and located between a pair of clamping plates, the pressurizing top rod is arranged at a telescopic end of the pressurizing cylinder, the proportional valve is arranged on the pressurizing cylinder, and the pressurizing cylinder is controlled by the proportional valve to drive the pressurizing top rod downward to pressurize the grinding fixture located on the grinding machine.

10. The automatic grinding line for grinding MPO optical fiber jumper according to claim 9, the lower end of the lifting sliding plate is further provided with a longitudinal telescopic assembly, the fixture cylinder is arranged on the longitudinal telescopic assembly, the sliding plate is arranged on one side of the pressurizing cylinder, and opposite to the fixture cylinder.
